(19) United States
(12) Patent Application Publication
(10) Pub. No.: US 2008/0006586 A1
(43) Pub. Date: Jan. 10, 2008

(54) Method and apparatus for the production and delivery of monochloramine into water streams

(76) Inventors: Stephen Axtell, Mint Hill, NC (US); Robert Cumming, Williamsburg, VA (US); Sam M. Jaffe, Cookeville, TN (US); Jerry Johns, Gainesville, GA (US); Robert Kim, Wexford, PA (US); Joe Phillips, Barhamsville, VA (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 11/703,918

(22) Filed: Feb. 8, 2007

(30) Foreign Application Priority Data
Jul. 6, 2006 (US) PCT/US06/26245

(51) Int. Cl. C02F 1/76

(52) U.S. Cl. 210/754; 210/209

(57) ABSTRACT

Monochloramine is efficiently manufactured by introducing controlled quantities of an ammonia source and a chlorine source in a small side-stream of water in a small diameter pipe under turbulent flow conditions. The ammonia source and chlorine source can be injected in either order and are separated by a sufficient distance to ensure that the first chemical is adequately diffused throughout the water prior to the injection of the second chemical. A sufficient length of a mixing chamber insures that turbulent flow is maintained for a length of time sufficient to thoroughly mix the two chemicals to produce monochloramine. This mixing technique allows for the manufacture of high concentrations of monochloramine at atmospheric pressure without off gassing.

### CROSS-REFERENCE TO RELATED APPLICATIONS

This application claims benefit from International Application Serial No. PCT/US2006/026245, filed on Jul. 6, 2006 which claims priority to U.S. Provisional Application Ser. No. 60/697,614 filed, on Jul. 8, 2005.

### FIELD OF INVENTION

This disclosure relates to the field of treating and disinfecting water streams including potable, process, recreational and waste water. In particular, the disclosure relates to a method and apparatus for the efficient and effective mixing and production of monochloramine. It also relates to delivering the monochloramine into the target water streams in order to control, reduce or eliminate microbial load. Aspects of the disclosure also provide methods improving the safety in the production and delivery of monochloramine.

### BACKGROUND OF INVENTION

Monochloramine is the preferred form of chlorine treatment in potable water distribution systems. The term “distribution system” is used to describe the extended piping and holding tanks used to distribute potable water through a municipality. Monochloramine has become the preferred form of treatment, as monochloramine is less likely than traditional forms of chlorine (i.e., liquid chlorine, gaseous chlorine, sodium hypochlorite, etc.) to interact with organics that may be found in potable water distribution systems. Unfortunately, when chlorine interacts with organic materials it can form undesirable carcinogenic disinfection byproducts such as trihalomethanes (THMs).

In drinking water treatment, monochloramine is applied up to the maximum dosage of 4-mg/liter set by the EPA. Prior approaches to the application of monochloramine to a potable water distribution line have been to introduce a chlorine source and an ammonia source at separate points to the full flow of water in the line. As the water travels past these two injection points, monochloramine is randomly formed from the almost instantaneous reaction of ammonia and chlorine and the slower reaction of organic to chlorine is minimized. It has been thought that this process reduces the potential for the formation of THMs.

There are different types of chloramines that are described in the literature. Inorganic, or true, chloramines are produced by controlling the ratio of chlorine and ammonia during mixing. The three species of inorganic chloramine that can be formed by the chlorine-ammonia reaction are monochloramine (NH₂Cl), dichloramine (NHCl₂) and nitrogen trichloride (NCl₃, also known as trichloramine). Monochloramine is the preferred inorganic chloramine species for use in disinfecting drinking water distribution systems, as monochloramine is odorless and highly soluble in water. Dichloramine and nitrogen trichloride are not desirable because they are less soluble in water and can be the source of taste and odor issues. Nitrogen trichloride is an irritant and is highly insoluble and therefore easily stripped from water by aeration. Because of these characteristics, it is the only inorganic chloramine species that can off-gas to cause burning of the eyes and nasal passages.

The species of chloramine that is produced when combining ammonia and chlorine is determined largely by the ratio of chlorine to nitrogen (Cl₂:N) used in the mixing process. To ensure that desirable monochloramine is formed, prior art methods use a Cl₂:N ratio in the range of about 3:1 to 5:1, with a typical value of about 4:1. Ratios less than about 5:1 result in the presence of monochloramine and some excess ammonia in the distribution system. Unfortunately, excessive ammonia found in many potable water distribution systems can cause undesirable bacterial re-growth.

An entirely different set of compounds, known as organochloramines, result from the chlorination of organic materials. Organochloramines are responsible for causing foul tastes and odors in some drinking water systems. Some of these organochloramine compounds are relatively insoluble and can readily off-gas and cause human irritation. Organochloramines are responsible for producing the chlorinous odors commonly encountered in swimming pools, and are often described as “chloramines” even though they are not true inorganic chloramines. Organochloramines are also generally considered to be non-biocidal.

In the formation of inorganic chloramines, the application of ammonia and chlorine must be maintained at a specific ratio to minimize the formation of nitrogen trichloride and dichloramine. In prior approaches of forming chloramines, water treatment plants usually apply a slight excess feed of ammonia, in order to avoid the formation of undesirable nitrogen-chlorine compounds. While feeding excess ammonia is helpful in limiting the formation of these undesirable nitrogen-chlorine compounds, undesirably, the excess ammonia can cause problems of bacterial re-growth in the potable water distribution systems.

In the potable water treatment industry, prior approaches of forming monochloramine have been accomplished via chemical metering devices that allow the water treatment professional to estimate the amount of monochloramine formation. This metering approach involves the adjustment of two variable chemical pump controls, which must be adjusted proportionally to the flow of potable water in the main line. The monochloramine level is tested sufficiently down stream of the chemical addition points to allow for mixing of the ammonia and chlorine. Adjustments to the chemical metering devices may be made automatically to maintain the nitrogen to chlorine feed ratio.

The most common forms of the chlorine used in the formation of chloramines in the water treatment process are liquid chlorine packaged in special steel containers and sodium hypochlorite (bleach). The most common form of the nitrogen used is anhydrous ammonia, commonly stored and transported as a liquid in pressure vessels. Another form of ammonia is aqueous ammonia, NH₄OH, most commonly a 20-30 percent solution of ammonia in de-ionized or softened water.

While monochloramine is formed on site and is not regulated, the regulations involved in the transportation and storage of liquid chlorine and anhydrous and aqueous ammonia are substantial due to safety concerns. Bleach, although more expensive than liquid chlorine, is often used in order to reduce the regulations and safety concerns involved with the on site storage of liquid chlorine.

As is known in the art, the primary users of monochloramine today are large municipal water treatment plants. Many of these large facilities have the necessary systems in place to handle and store regulated chemicals such as liquid chlorine and anhydrous and aqueous ammonia. However, as the market opportunities for monochloramine expand into smaller water treatment plants and industrial plant settings, monochloramine production processes that do not rely upon regulated chemicals and therefore have lower safety concerns and associated costs will increasingly be in demand.

Potable water plants using monochloramine do so in order to meet the Safe Drinking Water Act regulations governing the amount of THMs allowed in drinking water, and not because the efficacy of monochloramine provides exemplary disinfection benefits. In fact, monochloramine is often considered a poor choice in potable water treatment plants due to the ability of other biocides such as chlorine dioxide, ozone and hypochlorous acid to contribute more disinfection credits. If not for the Safe Drinking Water Act regulations and the fact that monochloramine disinfection is less likely than chlorination to form THMs, there would be very few, if any, situations where water treatment professionals would contemplate using monochloramine in water treatment plants.

In a previously filed application PCT No. US03/21577, incorporated in its entirety by reference, it has been discovered that when organically laden process water, such as is found in poultry processing plants, is treated with more potent biocides (i.e., hypochlorous acid), the organic material in the process water reacts or otherwise interferes with the biocides which minimizes their effectiveness. On the other hand, since monochloramine is already reacted with ammonia and is less reactive than free chlorine, it has been surprisingly found that it remains available for disinfection in such food processing water streams that have a high organic load.

In the case of water flumes from food processing operations, such as vegetable washes and poultry processing immersion chiller water, chlorine has been traditionally used as the antimicrobial of choice, but unfortunately with inconsistent results. As it has been discovered, the result of chlorination in these organically laden waters results in compounds that test positive for active forms of chlorine, but are actually non-biocidal forms of organochloramines.

It has been found that monochloramine surprisingly achieved a nominal one-log improvement in reducing microbial counts in organically laden food processing waters over the traditional antimicrobials. Without being bound to any particular theory, it is thought that this improved reduction in microbial counts is attributed to the increased contact time available with the weaker monochloramine antimicrobial due to its continued presence in the water. This extended contact time results in greater antimicrobial efficacy than is achievable by the stronger products, i.e. bleach, that are consumed or absorbed by the organic load in the water in a very short period of time.

Unfortunately, in high organic environments, bromine, chlorine and ozone are not effective antimicrobial agents because they are consumed by the organic load in the water. While monochloramine is a weaker antimicrobial, it does not readily react with the organics in the water and it therefore is able to continue to perform its antimicrobial activity over an extended period of time. This slow acting but persistent antimicrobial method of action will produce superior efficacy as compared to stronger antimicrobial products that are rapidly consumed or absorbed by the organic load in the water.

Prior attempts to use potable water treatment industry established production and delivery techniques to treat organically laden process water streams have been found to be inadequate because of the organic material found in the process waters. The organics in a process water stream interfere with the formation of monochloramine and severely lower the quantity of high quality monochloramine produced since a substantial portion of the chlorine component intended for reaction with ammonia is consumed by the organics to form non-biocidal organochloramines.

Although the prior art methods of producing monochloramine in the full flow pipe of a potable water treatment plant distribution line are normally sufficient for large municipalities, in many cases the excess ammonia used in this manufacturing process can cause bacterial re-growth issues in the downstream distribution system. The standard methods to produce monochloramine used in large potable water treatment plants for producing monochloramine are inadequate for process water and other process fluid applications such as immersion chillers in poultry processing plants, cooling towers, vegetable water flumes, meat brine flumes, swimming pools and other recreational and process streams with organic load. The organics in the process water interfere with the production of monochloramine.

As a result of prior approaches to monochloramine production in water treatment systems and the use of inefficient mixing processes or a desire to limit formation of undesirable forms of inorganic chloramines (i.e., dichloramine and nitrogen trichloride), excess levels of ammonia are found in chloraminated water streams. This excess ammonia coupled with the degradation of monochloramine over time can produce sufficient ammonia-N to cause nitrification in the water stream. Nitrification occurs when nitrifying bacteria such as Nitrosomonas and Nitrobacter consume ammonia. Unfortunately, one of the by-products of the nitrification process is nitrite. When nitrite is formed it can react with naturally occurring nitrosatable nitrogen precursors such as dimethylamine (DMA) to form potentially carcinogenic N-nitrosamines such as N-nitrosodimethylamine (NDMA). In addition to the potential nitrification of a water stream, excess free ammonia can contribute to increasing the corrosiveness of the water to yellow metals (copper and copper alloys).

### SUMMARY OF INVENTION

According to the invention a method and apparatus for producing a high concentration of monochloramine on demand in an inventive and highly efficient mixing pipe system containing potable water is disclosed. In one aspect of the disclosure the monochloramine is produced in a make-up stream apparatus and immediately injected into an organically laden process water stream.

According to the invention, monochloramine can be efficiently manufactured by introducing controlled quantities of an ammonia source and a chlorine source in a small side-stream of water in a mixing chamber under turbulent flow conditions. The ammonia source and chlorine source can be injected in either order. The two injection points are separated by a sufficient distance to ensure that the first chemical is adequately diffused throughout the water prior to the injection of the second chemical. A sufficient length pipe forming the mixing chamber insures that turbulent flow is maintained for a length of time sufficient to thoroughly mix the two chemicals to produce monochloramine. This mixing technique according to the invention allows for the manufacture of high concentrations of monochloramine at atmospheric pressure without off gassing.

The preformed monochloramine according to the invention can then be injected into a main water stream to produce a selected concentration of monochloramine. More efficient mixing according to the invention eliminates the need to inject excess ammonia into the treated water stream, which minimizes the likelihood of nitrification and the formation of carcinogenic N-nitrosamines.

The method and apparatus according to the invention minimize the production of nitrogen trichloride and dichloramine and eliminate the necessity of using excess ammonia in the manufacturing process, which is often the case in other traditional monochloramine mixing techniques.

In a further aspect of the invention, rather than re-pressurizing a water stream or modifying the existing line pressure, the method and apparatus according to the invention is able to take any line pressure as it normally exists in the target water stream and produce superior mixing and monochloramine transfer results. The benefits of the method and apparatus according to the invention significantly improve the economics of using monochloramine as a water disinfectant. Additionally, the use of a non-regulated ammonia source such as ammonium chloride and a less hazardous chlorine source such as sodium hypochlorite reduce the regulatory burdens and costs often encountered in traditional monochloramine production techniques.

For potable water treatment plant applications with the method and apparatus according to the invention, exact proportions of the chlorine and ammonia containing ingredients can be metered into a potable water side-stream, thoroughly mixed in the inventive mixing chamber described herein, and then injected back into the main process water stream without creating an off-gassing issue or introducing excess ammonia that could act as a nutrient for subsequent bacterial growth.

The method and apparatus according to the invention for monochloramine production described herein will also be more desirable for small water treatment plant applications where the water flow rates swing widely, since the monochloramine is manufactured only as needed and can be applied in direct proportion to the flow rate and more easily controlled via proportional control logics and metering pumps at a lower cost than full pipe flow monochloramine production.

For process water applications the same inventive process is used, but instead of a side-stream source of water, an independent source of potable water (make-up stream) is used for in-line manufacture of monochloramine, which is then injected into the organically laden process water stream. The use of potable water via a make-up stream of process water ensures the highest purity of monochloramine using the least amount of raw ingredients.

The benefits of using non regulated ammonia and safer chlorine source components will also be of great value to all producers of monochloramine.

### BRIEF DESCRIPTION OF THE DRAWINGS

The foregoing and other features and advantages of the present invention will be more fully understood from the following detailed description of illustrative embodiments, taken in conjunction with the accompanying drawing in which:

FIG. 1 illustrates the components comprising the monochloramine mixing apparatus according to the invention.

### DETAILED DESCRIPTION OF THE INVENTION

Detailed embodiments of the present invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the present invention in virtually any appropriately detailed embodiment.

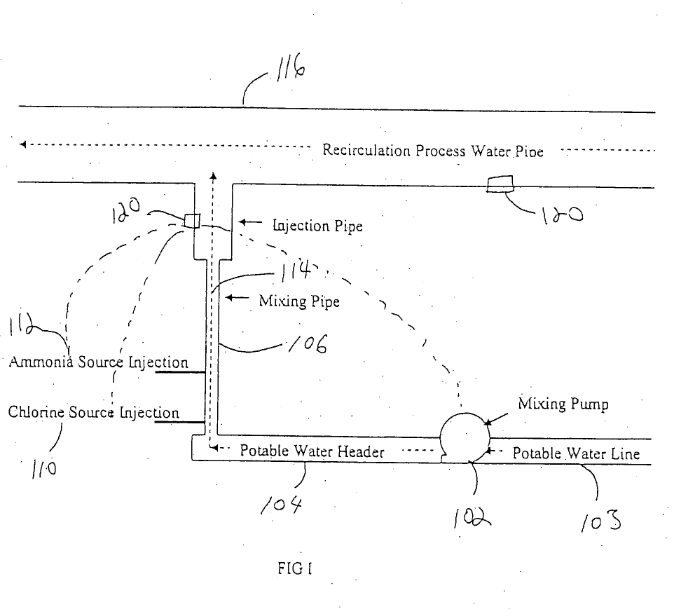

Turning to FIG. 1, a schematic of a monochloramine mixing apparatus 100 according to the invention is shown. The monochloramine mixing apparatus 100 has a mixing pump 102 that is in fluid communication with a potable water line 103. The mixing pump 102 is in further fluid communication with a potable water header pipe 104. The potable water header pipe 104 may supply any number of mixing apparatus 100 that feed different recirculation process water pipes 116. The mixing pump 102 (centrifugal or booster as appropriate for the conditions) is sized to maintain sufficient pressure and flow rate to deliver approximately 6.5 gpm through each approximately ½ inch pipe forming the mixing chamber 106. The mixing chamber 106 in a first illustrative embodiment is a pipe having an interior diameter of approximately ½ inch, which is approximately 25 feet in length. It is contemplated within the scope of the invention that the diameters and capacities of the various components can be sized according to the water treatment's capacity and requirements.

The mixing chamber 106 is in further fluid communication with an injection chamber 108, which in a first illustrative embodiment is a pipe having an interior diameter of approximately ¾ of an inch. The water in the potable water line 103 and potable water header 104 is maintained under laminar flow conditions. According to the invention, when the water enters the reduced diameter mixing chamber 106 at approximately 6.5 gpm, bubble froth turbulence results.

An aqueous chlorine source 110, which in this first illustrative embodiment is sodium hypochlorite, is injected into the mixing chamber 106 at a location toward the beginning point of the mixing chamber 106. At a point approximately one third of the distance down the mixing chamber 106, after the injected chlorine has been thoroughly dispersed throughout the water stream, a liquid ammonia source 112 is injected into the mixing chamber 106 forming a combined water stream 114. It is contemplated within the scope of the invention that the ammonia source 112 can be added to the mixing chamber 106 prior to the chlorine source 110. The combined water stream 114, containing chlorine and ammonia flow through the mixing chamber 106 in bubble froth turbulence forming monochloramine. By using the mixing technique described in this invention, we are able to control the mixing ratio of chlorine to ammonia at an about 5:1 ratio. The chlorine to nitrogen ratio of about 5:1 is a ratio maximizing production of monochloramine and minimize other undesirable compounds such as nitrogen trichloride or excess levels of ammonia.

According to a first illustrative embodiment of the invention the ammonia source 112 that is contemplated within the scope of the invention is ammonium chloride. Ammonium chloride has a pH of about 5 to 6 in an about 1% to 10% aqueous solution. The pH of ammonium chloride is particularly advantageous for the application described in this disclosure. As long as the pH is less than about 7, virtually all of the ammonia-nitrogen in the solution is in the form of the ammonium ion, which will not off gas. The ratio of ammonium ion (NH₄+) to ammonia (NH₃) is totally pH dependent.

As the pH goes up, the ammonium ion is converted to ammonia, which is a gas and can come out of solution. This lack of off gassing of ammonium chloride is important related to worker safety during transportation, storage and handling. Additionally, ammonium chloride is not considered a hazardous chemical and is therefore not subject to hazardous chemical regulations of the DOT. It is contemplated within the scope of the invention that sources for the nitrogen component of monochloramine include but are not limited to ammonium sulfate, ammonium hydroxide and ammonium chloride.

After mixing in the mixing chamber 106, the injected chlorine and ammonia along with the potable water form a combined water stream 114. The combined water stream 114 contains a selected amount of monochloramine that enters the injection chamber 108. Laminar flow conditions are restored through injection chamber 108. According to the invention, the mixing chamber 106 has been sized to accomplish a desired velocity and residence time for the mixing of the potable water, chlorine source 110 and ammonia source 112 in bubble froth turbulence. In a first illustrative embodiment, the mixing chamber 106 is a pipe having numerous bends in order to fit the mixing chamber 106 within a limited space. In one illustrative embodiment a straight pipe is preferable in order to form the mixing chamber 106 that does not negatively impact the bubble froth turbulent mixing, however, a pipe with bends is acceptable to form the mixing chamber 106. However, when using a bended pipe it will need to be somewhat longer than would otherwise be required if the mixing chamber 106 were a straight pipe. It is contemplated within the scope of the invention that the mixing chamber 106 can have an interior configuration of any geometric shape.

The mixing chamber 106 creates an environment in which there is bubble froth turbulence, when the laminar flow potable water enters it. According to the invention, bubble froth turbulence rather than plug flow or slug flow turbulence is preferable. The bubble froth turbulence within the mixing chamber 106 at a desired velocity and for a necessary residence time allows for the efficient mixing of the chlorine source 110, ammonia source 112 and potable water.

In order to accomplish the desired bubble froth turbulence for the necessary period of time the diameter and length of the pipe used in a first illustrative embodiment to form the mixing chamber 106 must fit within certain parameters. In order to determine the diameter and length of the pipe forming the mixing chamber 106 the following system requirements must be met. The flow rate through the entire system must be determined. In the system described in the above first illustrative embodiment the flow rate is sufficient to supply 6.5 gpm through each mixing loop. The desired material to be used in the pipe forming the mixing chamber 106 is selected and a Reynolds Number for the flow of water through the pipe constructed of the desired material is determined.

It is contemplated within the scope of the invention that any standard piping material that is inert to ammonia and chlorine can be used to form the mixing chamber 106 (e.g., stainless steel, PVC tubing, etc.); however, different materials have different surface characteristics, which in turn impact the flow rates required to accomplish the desired bubble froth turbulence in the mixing chamber 106.

The mixing chamber 106 in a first illustrative embodiment is made of Schedule 80 PVC. The diameter of the pipe forming the mixing chamber 106 and mixing pump 102 size are determined by incorporating the Reynolds Number for the selected piping material, volume flows and desired velocity of the flows. In a first illustrative embodiment, the velocity of the water/monochloramine stream while in bubble froth in the pipe forming the mixing chamber 106 is about ten feet per second.

The selected length of the pipe forming the mixing chamber 106 is a function of the pipe's diameter. The size of the pipe forming the mixing chamber 106 is determined by the overall system flow and the mixing pump 102 sizing to achieve a nominal velocity of about ten feet/second through the mixing chamber 106. The larger the pipe's diameter forming the mixing chamber 106, the longer the necessary length of the pipe forming the mixing chamber 106. The smaller the diameter, the smaller the pipe's length. Without being bound to any particular theory, it is thought that multiplying the diameter of the pipe forming the mixing chamber 106 by about 600 will produce an acceptable system (e.g., 600×Diameter=Length). This relationship between pipe's diameter and length forming the mixing chamber 106 is summarized below in table 1.

TABLE I

| Pipe Diameter | Pipe Length |
|---|---|
| 0.5 inches | 300 inches or 25 feet |
| 1.0 inches | 600 inches or 50 feet |
| 1.5 inches | 900 inches or 75 feet |
| 2.0 inches | 1,200 inches or 100 feet |
| 2.5 inches | 1,500 inches or 125 feet |
| 3.0 inches | 1,800 inches or 150 feet |

The combined water stream 114 containing monochloramine exits the mixing chamber 106 into the injection pipe 108 and flows directly to a recirculation process water pipe 116. There is no need to pass this combined water stream 114 through any sort of diffusion device before it enters the recirculation process water pipe 116.

The scope of the invention includes the use of monitors 120 that are incorporated into application points that are being fed by said recirculation process water pipe 116 for the purpose of controlling the level of monochloramine present at said application point. The monitors 120 in a first illustrative embodiment are monitors that measure total chlorine which includes monochloramine. Various regulatory guidelines require that total chlorine levels cannot exceed specified limits in poultry processing. The monitoring and control system in this first illustrative embodiment has a feedback control to said chlorine source 110 and said ammonia source 112. It is further contemplated within the scope of the invention that the monochloramine monitor 120 can have a feedback control to said mixing pump 102.

The flow from the potable water pipe 103 to the recirculation process water pipe 116 is a direct continuous flow. According to the invention, the use of a contact basin or system pressurization is not required, other than a normal pressure differential required to force the water through the mixing system and inject it into the process application. The mixing apparatus according to the invention allows the utilization of the existing normal pressure in the target water stream without any need for re-pressurization or other modification to the normal line pressure other than a normal pressure differential required to pull the water through the mixing system. This pressure differential can be very small since the only pressure differential required is that necessary to overcome line pressures.

### EXAMPLE I

The monochloramine mixing apparatus according to the invention was incorporated into a poultry processing plant. A substantial quantity of monochloramine was produced according to the invention. The target process water stream consisted of re-circulated process water from a poultry immersion chiller. In testing conducted at the poultry processing plant, concentrations of up to 3000 ppm of monochloramine were successfully added to the Recirculation Process Water Pipe 116, which through dilution in this stream is then diluted to about 50 ppm or less of total chlorine, which includes monochloramine, entering the poultry immersion chiller. With the monitoring control system, this level has been successfully controlled throughout a broad range of processing variations encountered over a sixteen-hour processing day.

### EXAMPLE II

According to the invention, diluting ammonium chloride to about a 24% solution allows it to be mixed in a tank of potable water and then re-circulated via a side-stream loop to which 12.5% sodium hypochlorite (i.e., bleach) was added to form monochloramine. When the desired ratio of Cl₂:N was achieved, the system was tested for monochloramine and metered into the process water. A day tank of up to 3,000 PPM of monochloramine could be safely produced with non-regulated components and reliably fed to a process water stream.

Although, the above illustrative embodiments show the use of the mixing apparatus in poultry processing plants, it will be appreciated by those skilled in the art that the inventive apparatus allowing for lower regulatory requirements of source chemicals will allow for new uses of monochloramine as a disinfectant to control microbial growth in other organically laden water and other fluid streams. Likewise, it will be appreciated by those skilled in the art that given a sufficient amount of contact time, the long-lasting persistence of monochloramine in organically laden water and other fluid streams offers a superior alternative to many fast acting and highly reactive disinfectants such as chlorine, chlorine dioxide, hypochlorous acid, ozone and bromine. Furthermore, it will be appreciated that in refineries, ammonia plants, pasteurizers, paper mills, organic chemical plants and similar classes of industrial plants, organic contamination of process water and other fluid streams often causes microbiological fouling which often becomes the major problem in accompanying water treatment and other industrial maintenance programs. In recreational swimming pools and spas with a high organic load, traditional chlorine and bromine treatment are not effective antimicrobials. It should be appreciated by those skilled in the art, that the use of monochloramine according to the invention offers significant advantages to traditional antimicrobials in all of these situations.

Although the illustrative embodiment herein show the use of monochloramine in poultry processing systems, it will be appreciated by those skilled in the art that the side stream or make-up stream apparatus can be used in any water or other fluid stream needing disinfection such as the treatment of water in cooling towers in those environments where there is an opportunity for the cooling water to be exposed to high levels of organics. As is known in the art traditional cooling tower feed water is potable water. In order to optimize performance of the cooling tower and related heat exchange system, the water in cooling towers is treated to control for corrosion, scaling and bacterial growth. In those situations where there are high levels of organics in the cooling tower water, it becomes extremely hard to control bacterial growth.

It will also be appreciated by those skilled in the art that cooling towers that are located in industrial areas where high levels of organics are in the air (e.g., petroleum refining plants, ammonia plants, pasteurizers, paper mills, organic chemical plants, etc.) will encounter the problems with bacterial growth. For example, petrochemical cooling towers are susceptible to organic contamination from process leaks and airborne scrubbing or organic vapors from processes. In a cooling water system, these contaminants can cause rapid, production limiting biological growth and must be countered by liberal use of non-oxidizing biocides. It will be further appreciated by those skilled in the art that the inability to control bacterial growth in these cooling towers can result in a variety of following problems: i) slime that builds up in the tower can block water flow and damage cooling tower fill and other tower structural components; ii) the evaporation performance of the tower can be limited due to plugging; and iii) flaking off of bacterial materials can cause plugging of the heat exchangers. Likewise those skilled in the art will appreciate that the production of monochloramine according to the invention and its application to these waters can be an effective solution to these cooling tower problems.

It should be further appreciated by those skilled in the art that the methods and devices according to the invention for the production of monochloramine can be used to beneficially treat water in air scrubbers, air washers and head boxes in paper mills and other process water and other fluid streams in heavy organic environments.

It should also be further appreciated by those skilled in the art that the methods and devices according to the invention for the production of monochloramine can be used to apply monochloramine to applications that are in need of new biocides and that the ability to introduce new biocides are restricted due to EPA and other regulatory requirements for toxicity testing. EPA already approves monochloramine as it is used in drinking water supplies throughout the U.S. and the world. The toxicity of monochloramine has been studied extensively prior to its approval for use in the drinking water supply. Many of the regulatory hurdles that confront the introduction of new biocides and other chemicals relate to those products that are produced off-site and shipped to a customer location. Shipping and transportation of new chemicals requires costly registration procedures that can significantly delay the introduction of such products. Monochloramine is produced on site from the mixture of a chlorine and ammonia source. The regulatory hurdles and associated cost to produce monochloramine is less burdensome and costly than other biocides. Examples where the invention as described herein allows the application of monochloramine as a biocide includes paper mills which grind up wood to make a 1-3% sluice of fiber that is dewatered on a Fourdranier paper machine at high rates of speed. The wood sugars in the sluice plus the inherent biological presence in the wood cause the rapid growth of large slime and fungus masses on the machine. When these break off, they are dewatered with the paper and cause holes and spots, and can cause the paper to break on the machine resulting in lost production. To maintain control of the biological growth on these machines, biocides are used at significant levels and costs and at time produce only marginal results. The Kaolin clay business produces slurries of clay that are dewatered on rotary vacuum filters and because the clay is obtained from the ground, it has significant organic material and microorganisms. A large expense in the clay industry is from the application of biocides. Monochloramine is a superior biocide in organically laden water and other fluid streams. The invention described herein enables the efficient and cost effective production of monochloramine so that it can now be used to address such problems.

It should be further appreciated by those skilled in the art that the methods and devices according to the invention for the production of monochloramine can be used for disinfecting swimming pools and spas with high organic loads in the water. Traditionally swimming pool waters are disinfected with chlorine. When there is a high organic load in the swimming pool water, the chlorine being added to the water will form organochloramines, which are ineffective biocides, will tend to off-gas and can cause irritation to eyes and nasal passages. For other recreational pools and spas (e.g., hot tubs, etc.) bromine is often used for water disinfection. One of the problems with bromine treatment can be a skin rash. Those skilled in the art will appreciate the use of the inventive method and apparatus to disinfect the high organic loads associated with such recreational water.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method for treating water streams comprising:
providing a water stream to be treated,
providing a mixing chamber in fluid communication with a potable water source, said mixing chamber configured to allow at least a portion of said potable water to have bubble froth turbulence,
injecting a chlorine source into said mixing chamber,
injecting an ammonia source into said mixing chamber
forming a selected level of monochloramine from said nitrogen source and said chlorine source in said potable water; and
injecting said monochloramine containing water into said water stream to be treated.

2. The method of claim 1, wherein said ammonia source is selected for the group consisting of ammonium chloride, ammonium sulfate, ammonium hydroxide and ammonium chloride.

3. The method of claim 1, wherein said chlorine source is sodium hypochlorite.

4. The method of claim 1, wherein said water stream is selected from the group consisting of poultry processing plants, food stuff processing plants, recreational water pools and cooling towers.

5. The method of claim 1, wherein said mixing chamber is a coiled pipe having a round interior configuration.

6. The method of claim 1, wherein said mixing chamber is a straight pipe having a round interior configuration.

7. The method of claim 1, wherein said mixing chamber has an interior geometric configuration selected from the group consisting of round, square, rectangular, octagonal, hexagonal and pentagonal.

8. The method of claim 1 further comprising the step of providing an injection pipe in fluid communication with said mixing chamber, said injection pipe in further communication with said water stream to be treated.

9. The method of claim 1 further comprising the step of providing a mixing pump said mixing pump in fluid communication with said water stream to be treated and in further fluid communication with said mixing chamber.

10. The method of claim 8 further comprising the step of providing a monochloramine sensing device within said injection pipe said sensing device having a feedback mechanism to control said chlorine source and said ammonia source.

11. The method of claim 1 further comprising the step of providing a monochloramine sensing device within said water stream to be treated said sensing device having a feedback mechanism to control said chlorine source and said ammonia source.

12. An apparatus for the production of monochloramine for the treatment of water streams comprising:
a mixing chamber in fluid communication with a potable water source said mixing chamber configured to allow at least a portion of said potable water to have bubble froth turbulence,
a means for injecting a chlorine source into said mixing chamber,
a means for injecting an ammonia source into said mixing chamber, wherein a selected level of monochloramine is formed from said nitrogen source and said chlorine source combined in said mixing chamber containing potable water having said bubble froth turbulence; and
an injection chamber in fluid communication with said mixing chamber and in further fluid communication with said water stream to be treated.

13. The apparatus of claim 12, wherein said mixing chamber is a coiled pipe having a round interior configuration.

14. The apparatus of claim 12, wherein said mixing chamber is a straight pipe having a round interior configuration.

15. The apparatus of claim 12, wherein said mixing chamber has an interior geometric configuration selected from the group consisting of round, square, rectangular, octagonal, hexagonal and pentagonal.

16. The apparatus of claim 12 further comprising a mixing pump said mixing pump in fluid communication with said potable water source and in further fluid communication with said mixing chamber.

17. The method of claim 12 further comprising a monochloramine sensing device within said injection chamber said sensing device having a feedback mechanism to control said means for injecting chlorine and said means for injecting ammonia.

18. A method for treating water streams comprising:
providing a water stream to be treated,
providing a mixing chamber in fluid communication with said water stream to be treated, said mixing chamber configured to allow at least a portion of said water stream to be treated to have bubble froth turbulence,
injecting a chlorine source into said mixing chamber,
injecting an ammonia source into said mixing chamber
forming a selected level of monochloramine from said nitrogen source and said chlorine source in said at lease a portion of said water stream to be treated; and
injecting said monochloramine containing water into said water stream to be treated.
